(19) United States
(12) Patent Application Publication
(10) Pub. No.: US 2007/0174856 A1
(43) Pub. Date: Jul. 26, 2007

(54) OPTICAL DISC DRIVE

(75) Inventors: Yao-Jia Chiou, Taipei (TW); Yi-Wei Lu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/610,508

(22) Filed: Dec. 14, 2006

(30) Foreign Application Priority Data
Jan. 24, 2006 (TW) 95102574

(51) Int. Cl. G11B 17/04

(52) U.S. Cl. 720/623

(57) ABSTRACT

An optical disc drive suitable for accommodating an optical disc is provided. The optical disc drive includes a housing, a rack, a swing arm and a cushion. The rack is disposed inside the housing, and the swing arm is pivoted to the rack. When an optical disc moves to a first disc location of the rack, the disc pushes the swing arm to rotate from a first arm location to a second arm location. When the disc returns from the first disc location back to a second disc location, the swing arm rotates from the second arm location back to the first arm location. The cushion is disposed to cover a protruding portion of the swing arm for buffering an impact.

### CROSS-REFERENCE TO RELATED APPLICATION

This application claims the priority benefit of Taiwan application serial no. 95102574, filed on Jan. 24, 2006. All disclosure of the Taiwan application is incorporated herein by reference.

### BACKGROUND OF THE INVENTION

1. Field of the Invention

The present invention relates to an optical disc drive. More particularly, the present invention relates to an optical disc drive with a lower noise production.

2. Description of the Related Art

Following the rapid advance in information technology, computer has become an indispensable tool in our daily life. To render the computer more useful, many peripheral products and add-ons are produced to enhance the capability of the computers. Nowadays, data storage devices include not only floppy drives and disk drives, but also the high storage capacity optical disc drives as well. The optical disc drives can be classified the tray-type optical disc drives and the slot-in type optical disc drives according to the mechanism for loading an optical disc into an optical disc drive.

To accommodate optical discs of different size (for example, 8 cm-diameter and 12 cm-diameter optical discs), the tray-type optical disc drive has positioning grooves having two depth levels for temporarily positioning the two aforementioned optical discs of different size. Besides, to achieve the same type of positioning for a slot-in type optical disc drive, a positioning mechanism is deployed for distinguishing the optical discs of different sizes and positioning the optical disc accordingly.

The positioning mechanism of the slot-in type optical disc drive is installed inside a housing of the optical disc drive. The positioning mechanism includes a rack, a pair of positioning arms pivoted to the rack, and a controlling arm pivoted to the rack. Each of the positioning arms has a positioning cylinder so that the two positioning arms together can limit the location of the optical disc in the housing. Furthermore, each of the positioning cylinders also passes through a guiding slot to limit the range of movement of the positioning arms.

When an 8 cm-diameter optical disc is driven to move to a first preset location or move away from the first preset location, the foregoing controlling arm will not be driven due to the smaller size of the 8 cm-diameter optical disc. Therefore, the positioning cylinders of the two positioning arms will not move so that the 8 cm-diameter disc is constrained within the first preset location. On the contrary, when a 12 cm-diameter optical disc is driven to move to a second preset location different from the foregoing first preset location, the 12 cm-diameter optical disc will drive the controlling arm so that the positioning cylinders of the two positioning arms will move and constrain the 12 cm-diameter optical disc within the second preset location.

It should be noted that, when the 12 cm-diameter optical disc moves away from the second preset location, the 12 cm-diameter optical disc will drive the controlling arm to drive the two positioning arms to return back to their original locations respectively. However, when loaded springs try to return the positioning arms back to their original locations respectively, the positioning cylinders of the two positioning arms may hit the receding 12 cm-diameter optical disc or one end of the guiding slots of the rack respectively to produce some annoying banging noise.

### SUMMARY OF THE INVENTION

Accordingly, at least one objective of the present invention is to provide an optical disc drive with a lower noise production.

To achieve these and other advantages and in accordance with the purpose of the invention, as embodied and broadly described herein, the invention provides an optical disc drive suitable for accommodating an optical disc. The optical disc drive includes a housing, a rack, a swing arm and a cushion. The rack is disposed inside the housing, and the swing arm is pivoted to the rack. When an optical disc moves to a first disc location of the rack, the optical disc pushes the swing arm to rotate from a first arm location to a second arm location. When the optical disc returns from the first disc location back to a second disc location, the swing arm rotates from the second arm location back to the first arm location. The cushion is disposed to cover a protruding portion of the swing arm.

In one embodiment of the present invention, the rack has a guiding slot and the protruding portion of the swing arm moves within the guiding slot.

In one embodiment of the present invention, the protruding portion is a cylinder and the cushion is a soft sleeve, wherein the cushion slides into the protruding portion.

In one embodiment of the present invention, the cushion slides into the protruding portion with an interference structural fit.

In one embodiment of the present invention, the optical disc drive further includes a clipping ring and the clipping ring is bonded to the protruding portion to prevent the cushion from slipping away.

In one embodiment of the present invention, the protruding portion has a limiter for stationing the cushion.

In one embodiment of the present invention, the protruding portion is a plastic injected component.

In one embodiment of the present invention, the protruding portion is a bar and the cushion is a soft sleeve slid into the bar. Furthermore, the bar has an inverted barb for preventing the soft sleeve from slipping out of the bar after the soft sleeve has slid into the bar.

In one embodiment of the present invention, there is a buffer space between the cushion and the protruding portion for buffering a bumping action.

In one embodiment of the present invention, the cushion also has a slant surface for limiting the location of the optical disc.

The optical disc drive in the present invention has a cushion disposed on the protruding portion of the swing arm. Hence, the cushion can buffer the impact the swing arm imparted to the optical disc or one end of the guiding slot when an optical disc moves away from the optical disc drive. As a result, the discomforting noise produced when the swing arm makes contact with the optical disc or one end of the guiding slot is substantially minimized.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view of a slot-in type optical disc drive according to one embodiment of the present invention in the process of sucking in an optical disc.

FIG. 2 is a top perspective view showing the rack and its components of the optical disc drive shown in FIG. 1.

FIG. 3 is a bottom perspective view of the rack shown in FIG. 2.

FIG. 4 is a bottom view of the rack in FIG. 2 and an 8 cm-diameter optical disc positioned on the rack.

FIG. 5A is a bottom view showing a 12 cm-diameter optical disc at a first optical disc location of the rack shown in FIG. 2.

FIG. 5B is a bottom view showing a 12 cm-diameter optical disc at a second optical disc location of the rack shown in FIG. 2.

FIG. 5C is a bottom view showing a 12 cm-diameter optical disc at a third optical disc location of the rack shown in FIG. 2.

FIG. 6 is a perspective view showing the protruding portion and the cushion in FIG. 3 in a detached configuration.

FIG. 7 is a cross-sectional view of a cushion according to an embodiment of the present invention with a slant surface for limiting the position of the optical disc.

FIG. 8 is a cross-sectional view of a cushion according to an embodiment of the present invention with two slant surfaces for limiting the position of the optical disc.

FIG. 9 is a cross-sectional view showing a buffer space between the cushion and the protruding portion according to an embodiment of the present invention.

FIG. 10 is a perspective view showing a clipping ring limiting the cushion to the protruding portion according to an embodiment of the present invention.

FIG. 11 is a perspective view showing a limiter at one end of the protruding portion limiting the cushion to the protruding portion according to an embodiment of the present invention.

FIG. 12 is a perspective view showing a cushion limited to the protruding portion through an inverted barb on a bar according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

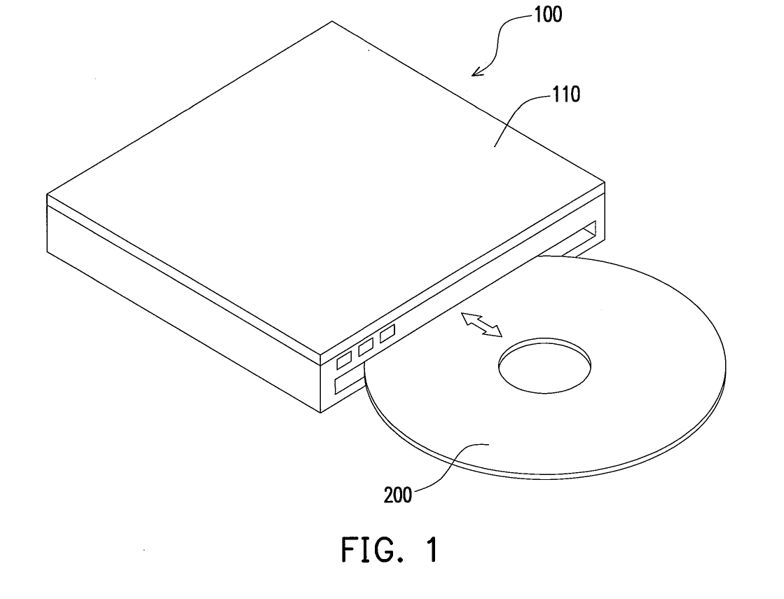

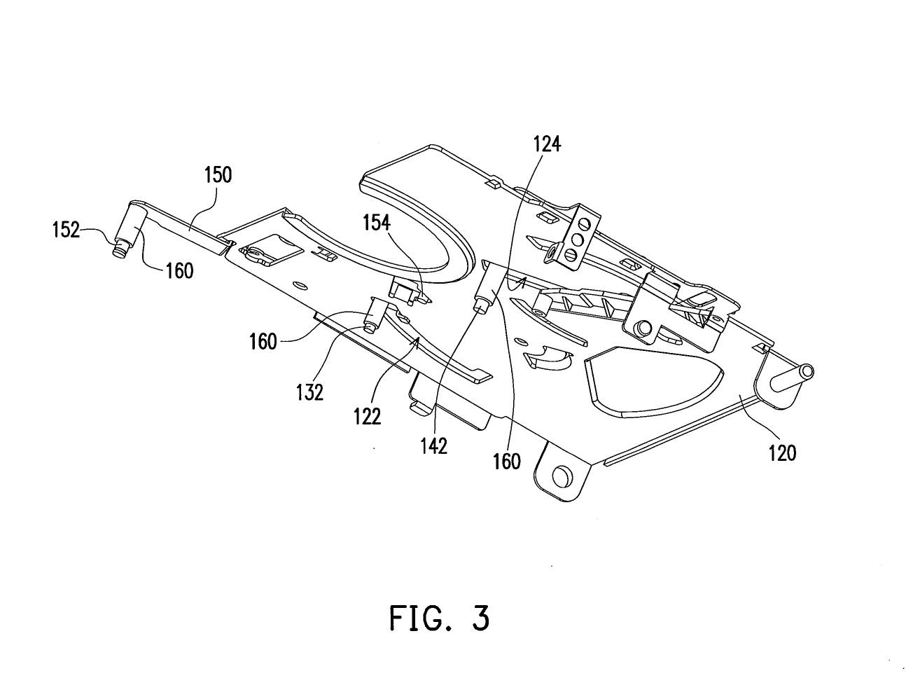

FIG. 1 is a perspective view of a slot-in type optical disc drive according to one embodiment of the present invention in the process of sucking in an optical disc. As shown in FIG. 1, the optical disc drive 100 in the present embodiment is a slot-in type optical disc drive capable of sucking in and accommodating a 12 cm-diameter optical disc 200 and writing data to or reading data from the 12 cm-diameter optical disc 200. Obviously, the optical disc drive 100 in the present embodiment may also suck in and accommodate an 8 cm-diameter optical disc 300 (as shown in FIG. 3) and writing data to or reading data from the 8 cm-diameter optical disc 300.

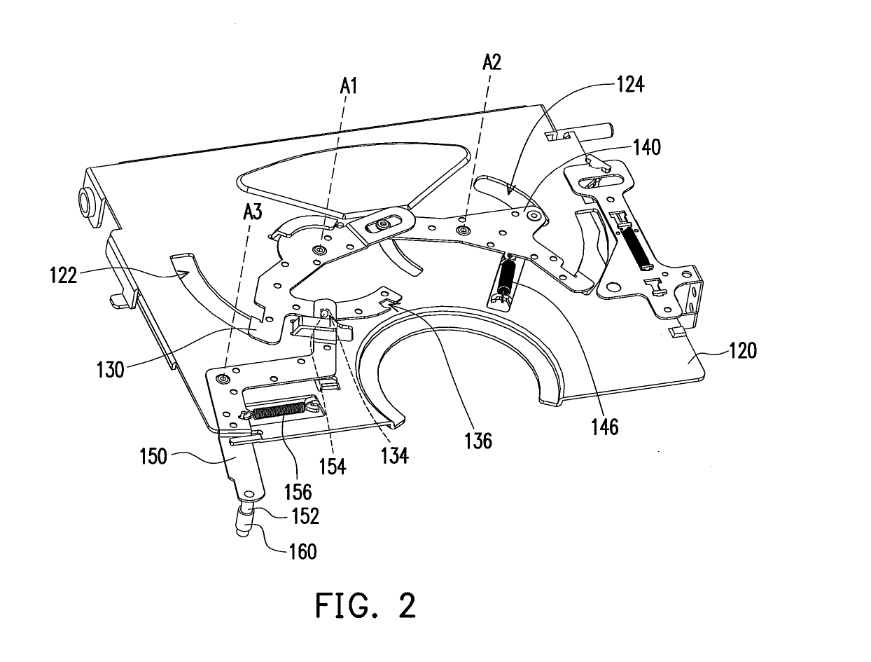

FIG. 2 is a top perspective view showing the rack and its components of the optical disc drive shown in FIG. 1. FIG. 3 is a bottom perspective view of the rack shown in FIG. 2. As shown in FIGS. 1, 2 and 3, the optical disc drive 100 includes a housing 110, a rack 120, a first positioning arm 130, a second positioning arm 140, a control arm 150 and a plurality of cushions 160. The rack 120 is disposed inside the housing 110. The first positioning arm 130, the second positioning arm 140 and the control arm 150 are pivoted to the rack 120. The cushions 160 are disposed on a protruding portion 132 of the first positioning arm 130, a protruding portion 142 of the second positioning arm 140 and a protruding portion 152 of the control arm 150, respectively. Furthermore, the cushions 160 wrap the protruding portions 132, 142 and 152, respectively. In the present embodiment shown in FIGS. 1, 2 and 3, the protruding portions 132, 142 and 152 are cylinders and the cushions 160 are soft sleeves that slide into the protruding portions 132, 142 and 152 respectively.

The first positioning arm 130 (another protruding portion of the first positioning arm 130) is pivoted to the second positioning arm 140. When the first positioning arm 130 rotates in a clockwise direction with respect to the axis Al shown in FIG. 2, the second positioning arm 140 will rotate in a counter-clockwise direction with respect to the axis A2 shown in FIG. 2. Conversely, when the first positioning arm 130 rotates in a counter-clockwise direction with respect to the axis A1, the second positioning arm 140 will rotate in a clockwise direction with respect to the axis A2.

To limit the range of rotation of the first positioning arm 130 and the second positioning arm 140, the rack 120 has a first guiding slot 122 and a second guiding slot 124. The protruding portion 132 of the first positioning arm 130 protrudes into the first guiding slot 122 and the protruding portion 142 of the second positioning arm 140 protrudes into the second guiding slot 124, as shown in FIG. 3. As a result, the first positioning arm 130 is permitted to rotate within the physical limit dictated by the first guiding slot 122 and the second positioning arm 140 is permitted to rotate within the physical limit dictated by the second guiding slot 124.

As shown in FIG. 2, the rack 120 further includes a spring 146 that pulls the second positioning arm 140 to rotate in a clockwise direction relative to the axis A2 so that the first positioning arm 130 is driven to rotate in a counter-clockwise direction relative to the axis A1. In addition, another spring 156 is set up between the rack 120 and the control arm 150 and pulls the control arm 150 to rotate in a counter-clockwise direction with respect to the axis A3.

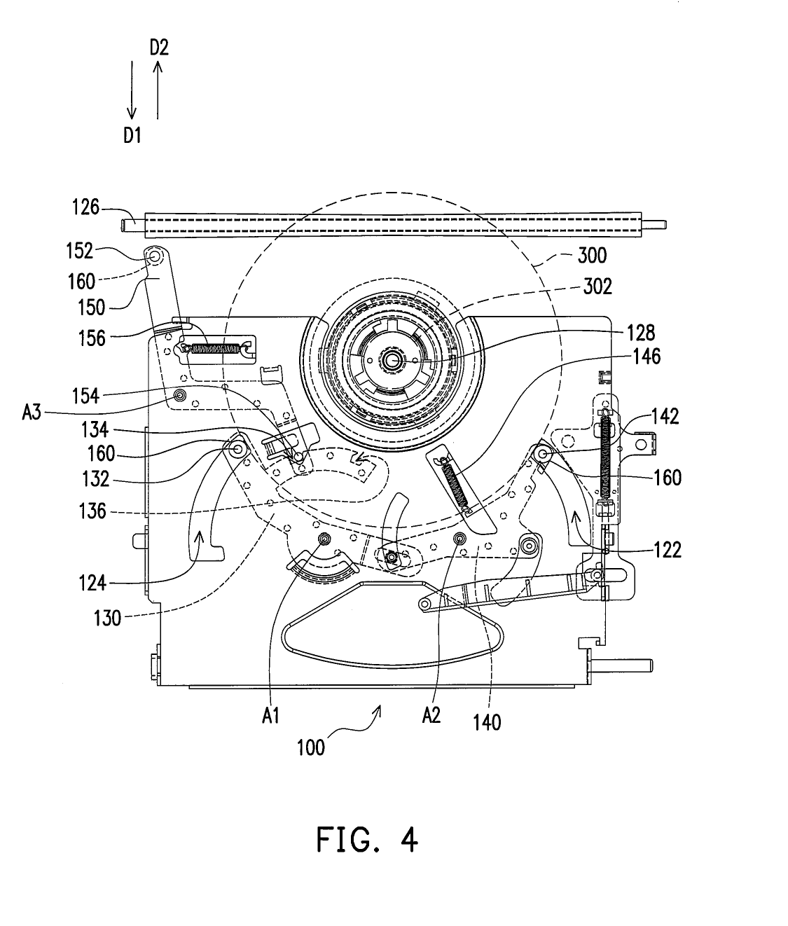

To control the location of the first positioning arm 130 and the second positioning arm 140, the control arm 150 has a latching block 154 (as shown in FIGS. 2 and 3) suitable for wedging into a first latching groove 134 or a second latching groove 136 of the first positioning arm 130. In FIG. 2, the latching block 154 wedges into the first latching groove 134. FIG. 4 is a bottom view of the rack in FIG. 2 and an 8 cm-diameter optical disc positioned on the rack. As shown in FIGS. 2 and 4, when the latching block 154 has wedged into the first latching groove 134, the central hole 302 of the 8 cm-diameter optical disc 300 driven by a roller 126 into the interior of the housing 110 of the optical disc drive 100 can be positioned directly above a optical disc clamp 128 of the optical disc drive 100 through the constraints provided by the protruding portion 132 of the first positioning arm 130 and the protruding portion 142 of the second positioning arm 140.

When the 8 cm-diameter optical disc 300 move into the optical disc drive 100 in the direction D1 or move out of the optical disc drive 100 in the direction D2, it will not push the protruding portion 152 of the control arm 150 because of its dimension. Hence, the protruding portion 132 of the first positioning arm 130 and the protruding portion 142 of the second positioning arm 140 will remain in the position shown in FIG. 4.

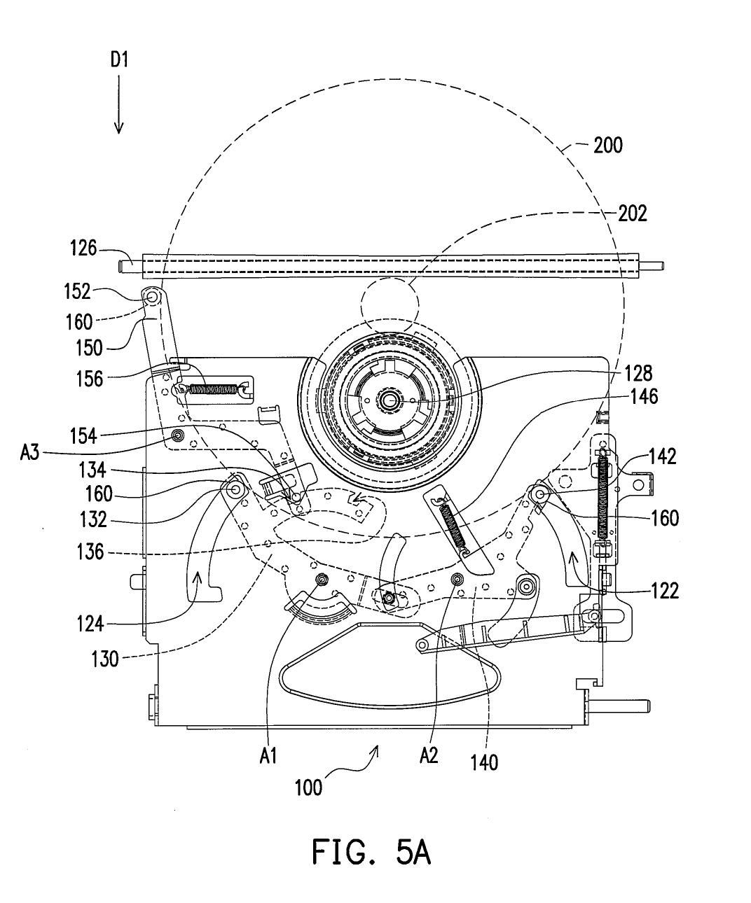

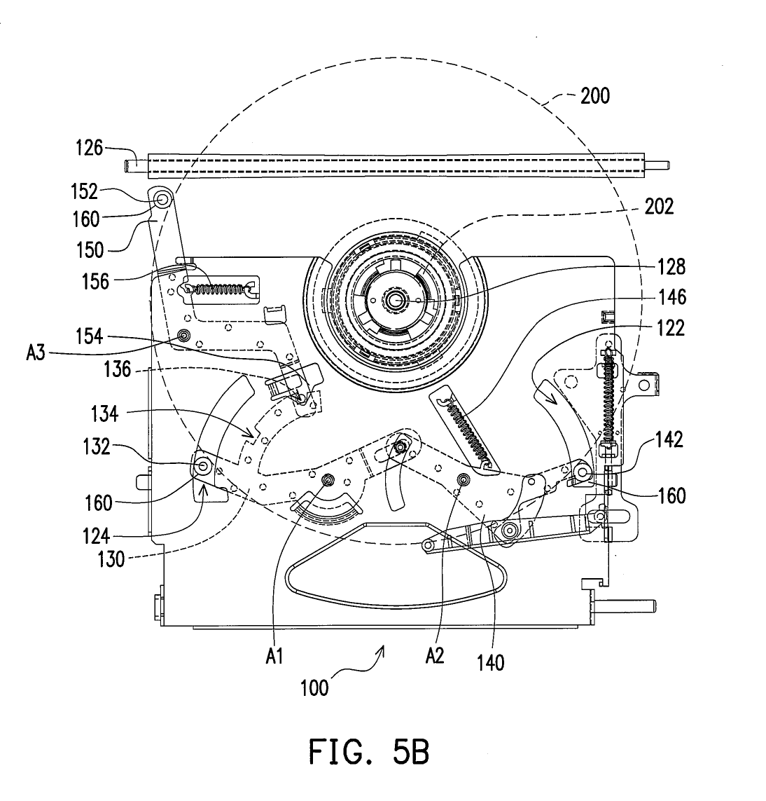

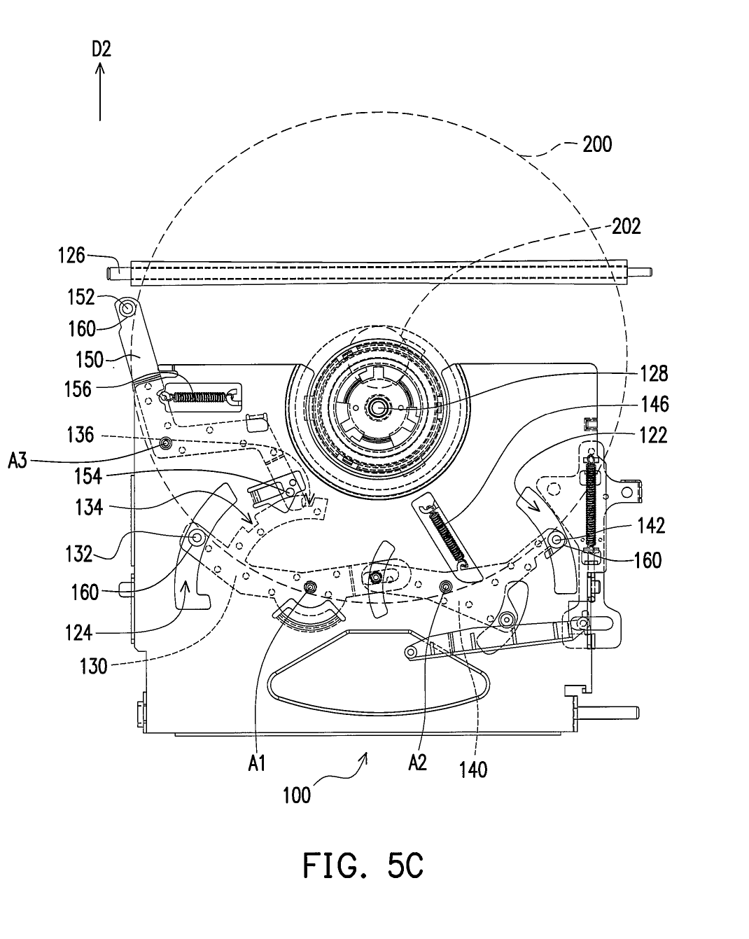

FIG. 5A is a bottom view showing a 12 cm-diameter optical disc at a first optical disc location of the rack shown in FIG. 2. FIG. 5B is a bottom view showing a 12 cm-diameter optical disc at a second optical disc location of the rack shown in FIG. 2. As shown in FIGS. 2, 5A and 5B, a 12 cm-diameter optical disc 200 driven by the roller 126 to move in the direction D1 into the optical disc drive 100 will push the protruding portion 152 of the control arm 150. Hence, the control arm 150 will rotate a counter-clockwise rotation relative to the axis A3 in FIG. 5A so that the latching block 154 of the control arm 150 detaches from the firs latching groove 134 of the first positioning arm 130. As a result, the 12 cm-diameter optical disc 200 moving in the direction D1 will push the protruding portion 132 of the first positioning arm 130 to rotate in a counter-clockwise rotation relative to the axis A1 in FIG. 5A. In the meantime, the movement of the 12 cm-diameter optical disc 200 in the direction D1 will also push the protruding portion 142 of the second positioning arm 140 to rotate in a clockwise rotation relative to the axis A2 in FIG. 5A.

After the outer edge of the 12 cm-diameter optical disc 200 stops pushing the protruding portion 152 of the control arm 150, the forward movement of the 12 cm-diameter optical disc 200 in the direction D1 will push the protruding portion 132 of 15 the first positioning arm 130 to rotate in a counter-clockwise direction relative to the axis A1 in FIG. 5A and push the protruding portion 142 of the second positioning arm 140 to rotate in a clockwise direction relative to the axis A2 in FIG. 5A. The rotation of the first positioning arm 130 and the second positioning arm 140 will continue until the latching block 154 of the control arm 150 has wedged onto the second latching groove 136 of the first positioning arm 130. Hence, the central hole 202 of the 12 cm-diameter optical disc 200 is disposed directly above an optical clamp 128 (as shown in FIG. 5B) through the constraints imposed by the protruding portion 132 of the first positioning arm 130 and the protruding portion 142 of the second positioning arm 140.

FIG. 5C is a bottom view showing a 12 cm-diameter optical disc at a third optical disc location of the rack shown in FIG. 2. As shown in FIGS. 2, 5B and 5C, when the 12 cm-diameter optical disc 200 moves from the second optical disc position in FIG. 5B to the third optical disc position in FIG. 5C driven by the roller 126 in the direction D2, the outer edge of the 12 cm-diameter optical disc 200 will push the protruding portion 152 of the control arm 150 so that the control arm 150 will rotate in a counter-clockwise direction relative to the axis A3 in FIG. 5C. After the control arm 150 has undergone a clockwise rotation, its latching block 154 will detach from the second latching groove 136 of the first positioning arm 130. The spring 146 acting on the first positioning arm 130 causes the first positioning arm 130 to rotate in a counter-clockwise direction with respect to the axis A1 in FIG. 5C so that the second positioning arm 140 also rotate relative to the axis A2 (clockwise rotation in FIG. 5C). However, the force provided by the spring 146 may cause transient impacts of the protruding portion 132 of the first positioning arm 130 and the protruding portion 142 of the second positioning arm 140 with the outer edge of the 12 cm-diameter optical disc 200. Alternatively, the force provided by the spring 146 may cause transient impacts of the protruding portion 132 of the first positioning arm 130 and the protruding portion 142 of the second positioning arm 140 with one end of the first guiding slot 122 and one end of the second guiding slot 124 separately.

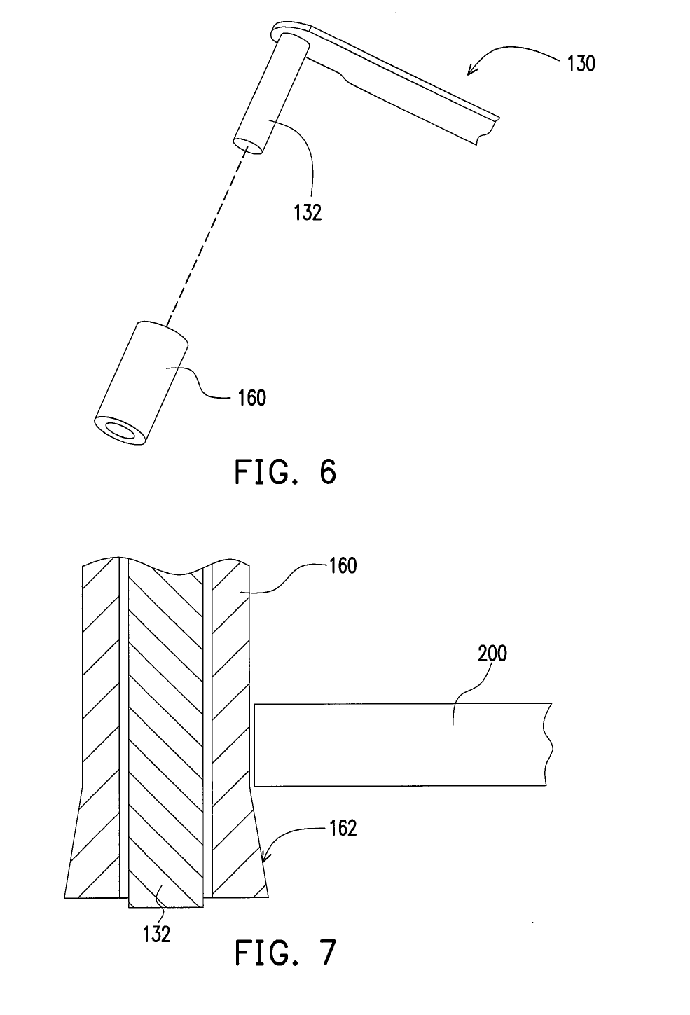

To prevent the protruding portion 132 and the protruding portion 142 from a transient impact with the outer edge of the 12 cm-diameter optical disc 200 or separately hitting one end of the first guiding slot 122 and one end of the second guiding slot 124, the optical disc drive 100 in the present embodiment includes a plurality of cushions 160. Two of the cushions 160 are set up on the protruding portion 132 of the first positioning arm 130 and the protruding portion 142 of the second positioning arm 140 respectively. FIG. 6 is a perspective view showing the protruding portion and the cushion in FIG. 3 in a detached configuration. As shown in FIGS. 3 and 6, the cushion 160 is slid into the protruding portion 132. When the protruding portion 132 impacts the outer edge of the 12 cm-diameter optical disc 200 or one end of the firs guiding slot 122, the cushion 160 can buffer the impact between the protruding portion 132 and the 12 cm-diameter optical disc 200 and lower overall noise level. Likewise, the cushion 160 disposed on the protruding portion 142 has a buffering effect similar to the one between the protruding portion 132 and the cushion 160. In addition, another of the cushions 160 can also be disposed on the protruding portion 152 of the control arm 150. With the cushion 160 disposed on the protruding portion 152, the cushion 160 can reduce the impact between the protruding portion 152 and the 12 cm-diameter optical disc 200 when the protruding portion 152 hits the outer edge of the 12 cm-diameter optical disc 200.

In the present embodiment, the cushions 160 are soft sleeves slid into the protruding portion 132, the protruding portion 142 and the protruding portion 152 respectively with an interference structural fit. In addition, the protruding portion 132, the protruding portion 142 and the protruding portion 152 can be plastic injection components to lower the production cost.

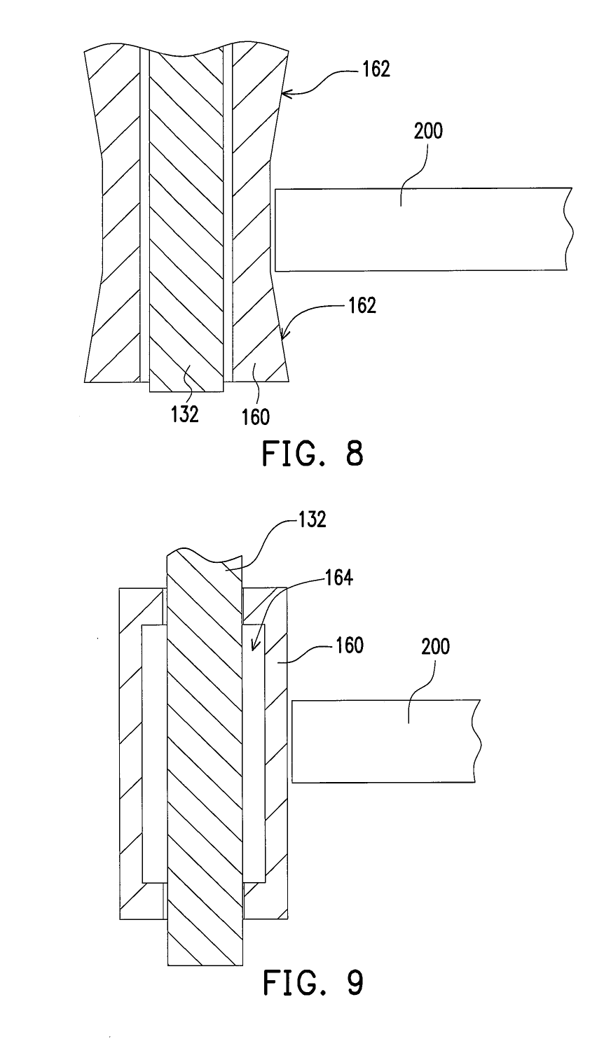

The protruding portion 132 is taken as an example from the protruding portions 132, 142 and 152. In another embodiment as shown in FIG. 7, a slant surface 162 can be set up on the cushion 160 on the protruding portion 132 to limit the movement of the 12 cm-diameter optical disc 120. Obviously, in another embodiment as shown in FIG. 8, both ends of the cushion 160 can have a slant surface 162 to provided a better position limiting effect on the 12 cm-diameter optical disc 200.

To increase the buffering effect of the cushion 160, a buffering space 164 is added between the cushion1 160 and the protruding portion 132 in another embodiment as shown in FIG. 9. With the additional buffering space 164, the cushion 160 can have sufficient deformation space for providing a better buffering effect.

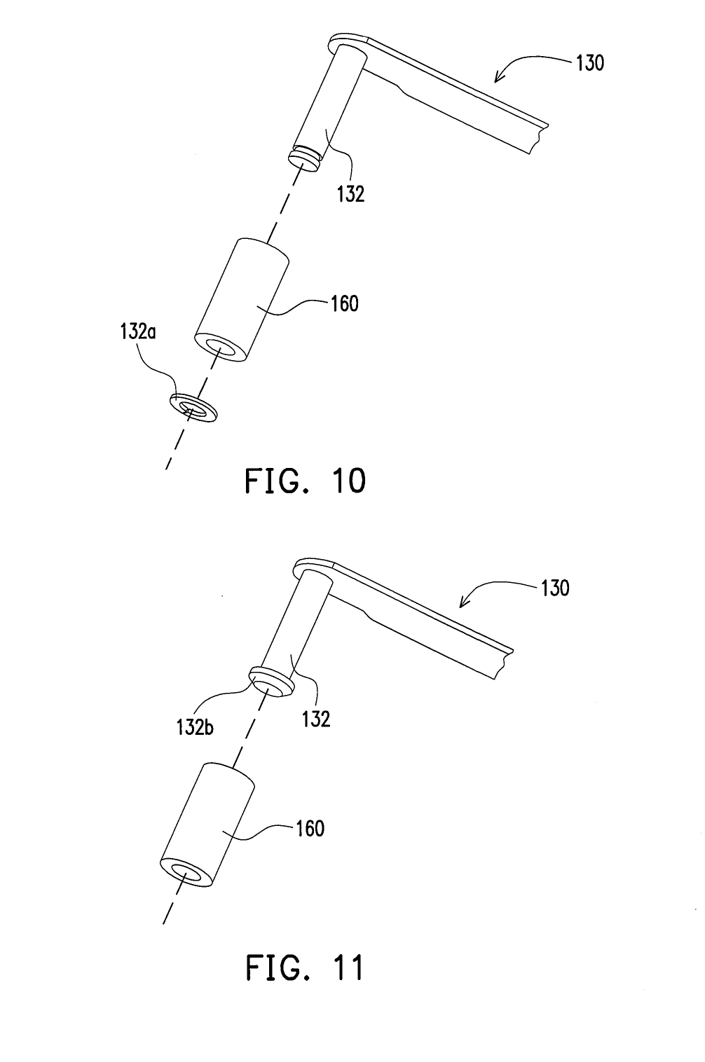

In another embodiment as shown in FIG. 10, the protruding portion 132 can have a clipping ring 132a attached to one end to prevent the cushion 160 slipping away from the protruding portion 132. In this way, the cushion 160 is prevented from slipping out again after sliding into the protruding portion 132.

In another embodiment as shown in FIG. 11, the protruding portion 132 can include a limiter 132b to prevent the cushion 160 from slipping out of the protruding portion 132. The limiter 132b has a function similar to the clipping ring 132a shown in FIG. 10.

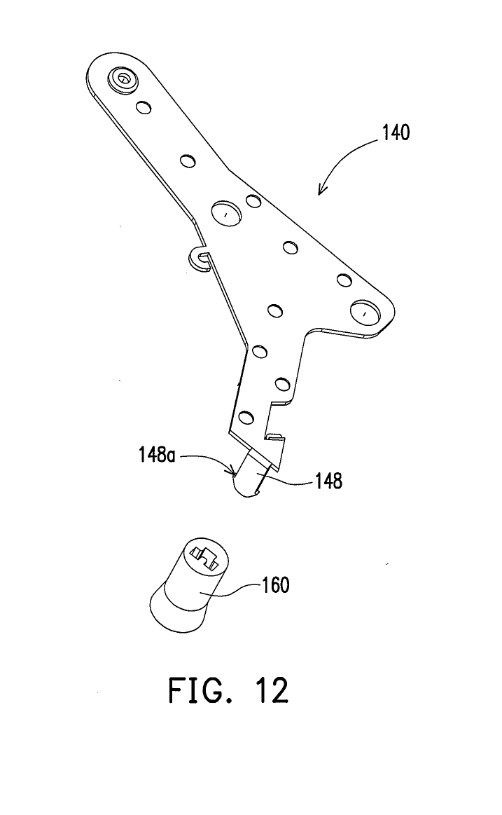

In yet another embodiment as shown in FIG. 12, the protruding portion 142 of the second positioning arm 140 is changed to a bar 148 bent out from the second positioning arm 140. Furthermore, the bar 148 can have an inverted barb 148a constructed of the bar 148 to prevent the cushion 160 already slid into the bar 148 from slipping out again.

In summary, the optical disc drive in the present invention has cushions disposed on all protruding portions for buffering the protruding portions against impact with the outer edge of the optical disc as well as one end of the guiding slots. Hence, noise production is significantly reduced. In addition, the protruding portions can be produced through a bar bent out from the positioning arm. Therefore, the number of components in the optical disc drive can be reduced to save production cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical disc drive suitable for accommodating an optical disc, comprising:
a housing;
a rack disposed inside the housing;
a swing arm pivoted to the rack so that when the optical disc moves to a first disc position of the rack, the optical disc pushes and rotates the swing arm from a first arm position to a second arm position, and when the optical disc returns from the first disc position back to a second disc position, the swing arm rotates from the second arm position back to the first arm position; and
a cushion disposed on a protruding portion of the swing arm, wherein the cushion wraps the protruding portion.

2. The optical disc drive of claim 1, wherein the rack has a guiding slot such that the protruding portion of the swing arm move along the guiding slot.

3. The optical disc drive of claim 1, wherein the protruding portion is a cylinder and the cushion is a soft sleeve slid into the protruding portion.

4. The optical disc drive of claim 1, wherein the cushion slides into the protruding portion with an interference structural fit.

5. The optical disc drive of claim 1, further comprising a clipping ring clipped to one end of the protruding portion for preventing the cushion from slipping out of the protruding portion.

6. The optical disc drive of claim 1, wherein the protruding portion has a limiter for fixing the cushion.

7. The optical disc drive of claim 1, wherein the protruding portion is a plastic injected component.

8. The optical disc drive of claim 1, wherein the protruding portion is a bar and the cushion is a soft sleeve that slides into the bar, and the cushion is prevented from slipping out through an inverted barb constructed of the bar.

9. The optical disc drive of claim 1, wherein a buffering space is set up between the cushion and the protruding portion for buffering an impact.

10. The optical disc drive of claim 1, wherein the cushion has a slant surface for limiting the position of the optical disc.
